(19) United States
(12) Patent Application Publication
(10) Pub. No.: US 2016/0171421 A1
(43) Pub. Date: Jun. 16, 2016

(54) SYSTEMS AND METHODS FOR PLANNING, ADMINISTERING, AND PRESENTING PERSONALIZED VIEWS

(71) Applicant: SuccessFactors, Inc., South San Francisco, CA (US)

(72) Inventor: Tanja Baeck, Wiesloch (DE)

(21) Appl. No.: 14/828,382

(22) Filed: Aug. 17, 2015

Related U.S. Application Data
(63) Continuation-in-part of application No. 14/567,228, filed on Dec. 11, 2014.

(51) Int. Cl. G06Q 10/06; G06Q 10/10

(52) U.S. Cl. CPC G06Q 10/063118; G06Q 10/1095

(57) ABSTRACT

A planning and management system is disclosed that includes: (1) a central planning module that enables a first party to assign a second party to a department and to view the schedules of other parties based on the departmental assignments; (2) a department-level view module that enables the first party to view schedules and detailed information through a profile for people that have been assigned to that department; and (3) a detailed-level view module that enables each party to view their individual schedules and profiles. In this manner, the system can facilitate planning, administration, and information exchange. The system can also generate a profile on a selected party where the profile has been customized for a particular viewer. The modules can be programmed in software code to be executed by a processor.

### CROSS-NOTING TO RELATED APPLICATIONS

This application claims the benefit of U.S. application Ser. No. 14/567,228, filed Dec. 11, 2014, entitled “AUTOMATED CONSECUTIVE SCHEDULING”, which is incorporated herein by reference in its entirety.

### BACKGROUND

Apprenticeship refers to the practice of training a new generation of practitioners (known as apprentices) in a trade or profession via on-the-job training and mentoring. Although first developed during the Middle Ages, apprenticeship schemes are still widely used today in countries such as Germany, Australia, Switzerland, Austria, France, and others. For example, apprenticeship is an integral part of Germany's dual education system. Under this dual system, students spend 50-70% of their time over a period of approximately three years working as an apprentice for a company in a particular trade/profession, and spend the remainder of their time in formal education. After completing their apprenticeships, the former apprentices are entitled to obtain employment in their fields of expertise. In Germany, there are currently 342 recognized trades (“Ausbildungsberufe”) in which an apprenticeship can be completed. These trades include craft-based professions, such as baking, tailoring, carpentry, etc., as well as business-oriented professions, such as finance, engineering, industrial management, etc.

One challenge for German companies (and companies in other countries where apprenticeship is prevalent) is managing information regarding the apprentices they hire for their various business units/departments. For instance, a large German company like Siemens or SAP may employ thousands of apprentices at a given time, spread across tens or hundreds of departments, which makes apprenticeship management a daunting task. Many companies have employee/human resource (HR) management systems that enable generic HR functions such as time-off/attendance, payroll, recruiting, learning management, and so on. However, existing employee/HR management systems are not designed to track and manage apprenticeship-specific data. Accordingly, such existing systems cannot be directly used by company stakeholders to plan, administer, and/or view information regarding the company's apprenticeships.

### SUMMARY

An apprenticeship planning and management system is disclosed. In various embodiments, the apprenticeship planning and management system can include: (1) a central planning module that enables a training supervisor of a company to assign apprentices to departments and view company-wide apprentice schedules based on the departmental assignments; (2) a department-level view module that enables an administrator of a particular company department to view schedules and detailed information for apprentices that have been assigned to that department; and (3) an apprentice-level view module that enables each apprentice to view their individual work/school schedules. In this manner, the system can facilitate planning, administration, and information exchange with respect to the company's apprenticeships. In some embodiments, an apprenticeship planning and management GUI can generate an apprentice profile. The apprentice profile can be generated by populating a presentation layout with information on a selected apprentice. In some examples, the apprenticeship planning and management GUI can select a presentation layout to apply based on the role of the employee requesting the apprentice profile. As a result, the apprenticeship planning and management GUI can generate an apprentice profile that contains the proper amount of detailed information depending on the employee.

### BRIEF DESCRIPTION OF THE DRAWINGS

FIG. 1 depicts a system environment that includes an apprenticeship planning and management system according to an embodiment.

FIG. 2 depicts a flowchart executable by a central planning module for enabling a user (e.g., training supervisor) to carry out company-wide apprenticeship planning/management according to an embodiment.

FIG. 3 depicts a calendar-based user interface generated by the central planning module according to an embodiment.

FIG. 4 depicts a flowchart for importing events into the calendar-based user interface of FIG. 3 according to an embodiment.

FIG. 5 depicts a flowchart for validating a departmental assignment for an apprentice according to an embodiment.

FIG. 6 depicts a flowchart executable by a department-level view module for enabling a user (e.g., department administrator) to view information regarding the apprentices assigned to a specific department according to an embodiment.

FIG. 7 depicts a calendar-based user interface generated by the department-level view module according to an embodiment.

FIG. 8 depicts a flowchart executable by an apprentice-level view module for enabling an apprentice to view his/her work and school schedules according to an embodiment.

FIG. 9 depicts a calendar-based user interface generated by the apprentice-level view module according to an embodiment.

FIG. 10 depicts a system environment that includes a human resource management system according to an embodiment.

FIG. 11 depicts an apprentice master data according to an embodiment.

FIG. 12 depicts an apprentice profile according to an embodiment.

FIG. 13 depicts another apprentice profile according to another embodiment

FIG. 14 depicts a flowchart for generating the apprentice profile of FIG. 12 according to an embodiment.

FIG. 15 depicts a computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

Embodiments of the present disclosure provide a system that can be implemented by a company (or a service provider contracted to provide software services to the company) for planning and managing the company's apprenticeships. At a high level, the system can include a central planning module, a department-level view module, and an apprentice-level view module. The central planning module can enable a training supervisor of the company to, e.g., define apprenticeship-specific data for apprentices hired by the company, define apprenticeship-specific data for departments/sub-departments within the company, assign apprentices to departments/sub-departments, and view calendar-based schedules for the apprentices based on their school periods, school vacation, department work periods, internal training events, requested time-off, and other events. In this way, the central planning module can facilitate the creation of per-department apprenticeship plans, as well as allow the training supervisor to visualize where each apprentice will be (and when) based on their departmental assignments.

The department-level view module can enable a department administrator (or other department user) to view the schedules of all apprentices that have been assigned to that department (and its constituent sub-departments) via the central planning module. For example, the department-level view module can generate a calendar-based UI that illustrates the time slots during which each apprentice will be working for the department, as well as other events that affect the availability of the apprentice (e.g., school periods, school vacation, internal training events, time-off, etc.). The UI can also display detailed information about each apprentice, such as their contact information, school, learning/training history, skills, and so on. Accordingly, the department-level view module can provide the department administrator with relevant information for planning and preparing effectively for the department's incoming group of assigned apprentices.

Finally, the apprentice-level view module can enable an apprentice that is employed with the company to view his/her individual work and school schedules. For example, the apprentice-level view module can generate a calendar-based UI that displays schedule information similar to the information presented via the central planning and department-level view modules (e.g., work times, school periods, school vacation, internal training events, time-off, etc.), but is specific to a single apprentice. In addition, the apprentice-level view module can provide the apprentice with information regarding his/her assigned department (e.g., departmental contact, office location, etc.). Thus, with this module, the apprentice can easily keep track of where he/she needs to be on a daily basis, and who to get in touch with if he/she has questions regarding the apprenticeship.

In certain embodiments, the apprenticeship planning and management system described above can be integrated with the company's existing employee/HR management system. For instance, upon receiving apprenticeship-specific data for apprentices or departments within the company, the central planning module can store this data as part of existing employee and department data objects/tables maintained by the company's employee/HR management system, rather than as new data objects or tables. This avoids the need to replicate employee/HR data in backend storage for apprenticeship management purposes.

In addition, the apprenticeship planning and management system can automatically pull data from the existing employee/HR management system as needed to provide additional contextual information to the various users of the central planning, department-level view, and apprentice-level view modules. For example, in one embodiment, the apprenticeship planning and management system can automatically pull information regarding time-off requested by each apprentice from an existing time-off/attendance module of the employee/HR management system. This time-off information can then be reflected in the calendar-based schedules generated for the training supervisor, department administrators, and apprentices. In another embodiment, the apprenticeship planning and management system can automatically pull learning/training data for each apprentice from an existing learning management module of the employee/HR management system, and can present this data in the department-level apprentice detail UIs.

These and other aspects of the present disclosure are described in further detail in the sections that follow.

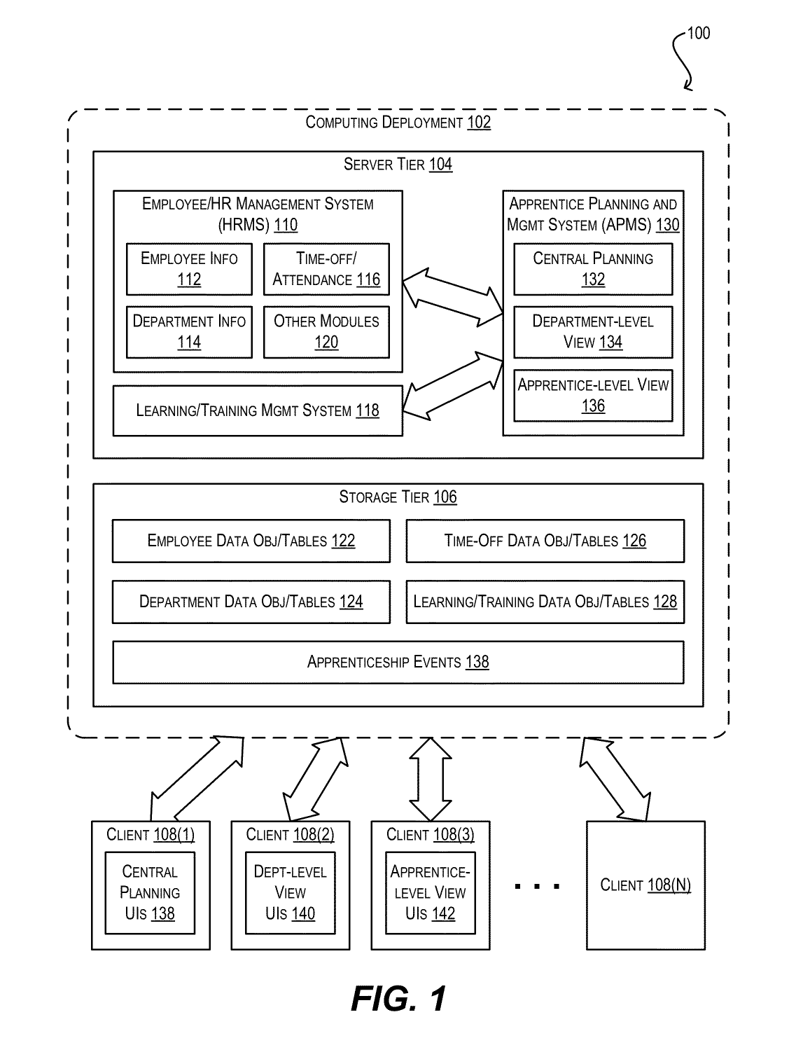

FIG. 1 depicts a system environment 100 that implements an apprenticeship planning and management system according to an embodiment. As shown, system environment 100 includes a computing deployment 102 that comprises a server tier 104 and a storage tier 106. Computing deployment 102 provides software services to employees of a particular company, such as users operating client devices 108(1)-108(N). In one embodiment, computing deployment 102 can be maintained by an internal information technology (IT) organization of the company. In other embodiments, computing deployment 102 can be maintained by an external service provider, such as a cloud service provider, that has agreed to host software services on behalf of the company.

Server tier 104, which can be implemented using one or physical computer systems, is configured to run (among other things) an employee/HR management system (HRMS) 110 for the company. An example of such an HRMS is SAP's Employee Central software suite. As shown, HRMS 110 includes an employee info module 112, a department info module 114, a time-off/attendance module 116, and other modules 120. Employee info and department info modules 112 and 114 can enable users of HRMS 110 to enter/maintain information regarding the employees and departments/sub-departments of the company respectively. Time-off/attendance module 116 can enable employees of the company to request and receive approval for time-off/vacation days. And other modules 120 can provide further features that are commonly implemented in conventional HRMSs, like payroll management, benefits management, employee performance tracking, and so on.

Server tier 104 further includes a learning/training management system 118 that can facilitate various aspects of employee training, such as providing employee access to online learning content and/or specific training curricula, tracking employee learning/training history, and so on. An example of such a system is the Learning Management System of the SuccessFactors' BizX Suite.

Storage tier 106 of computing deployment 102, which can be implemented using one or more physical storage components (e.g., dedicated storage arrays, commodity hard/flash disks, etc.), is configured to store persistent data on behalf of HRMS 110. For example, in FIG. 1, storage tier 106 stores employee data objects/tables 122 associated with employee info module 112, department data objects/tables 124 associated with department info module 114, time-off data objects/tables 126 associated with time-off/attendance module 116, and learning/training data objects/tables 128 associated with learning/training management system 118.

As noted in the Background section, one problem with existing HRMS implementations is that they are not designed to facilitate apprenticeship management. For example, assume that the company associated with computing deployment 102 is a German company (or a company in another country where apprenticeship is widely used) with a large number of apprentices spread across numerous departments. In this scenario, with existing

HRMS solutions, there would be no way for the various stakeholders in the apprenticeship process to directly use the HRMS in order to, e.g., assign apprentices to departments, view apprentice information and schedules, and so on.

To address these and other similar issues, server tier 104 of FIG. 1 includes an apprenticeship planning and management system (APMS) 130 (communicatively coupled with HRMS 110 and learning/training management system 118) that comprises a central planning module 132, a department-level view module 134, and an apprentice-level view module 136. As described in further detail below, these modules of APMS 130 can perform server-side processing and generate UIs for display on client devices 108(1)-108(N) (e.g., central planning UIs 138, department-level view UIs 140, and apprentice-level view UIs 142 shown within client devices 108(1), 108(2), and 108(3) respectively) that facilitate the planning, administration, and dissemination of information regarding the company's apprenticeships. For example, APMS 130 can capture and display apprenticeship events, such as group events and training, departmental work periods, offsite events, and the like (shown via reference numeral 138 in storage tier 106) via UIs 138-142. APMS 130 can also capture and display apprenticeship-specific employee and department data (stored as, e.g., part of employee data objects/tables 122 and department data objects/tables 124). Thus, APMS 130 can improve information access and streamline apprenticeship management for all of the company stakeholders/participants involved in the process (e.g., training supervisors, department administrators, and the apprentices themselves).

It should be appreciated that system environment 100 is illustrative and not intended to limit the embodiments discussed herein. For example, while APMS 130 is shown as being a separate component from HRMS 110, in some embodiments APMS 130 may be directly integrated into HRMS 110. In these embodiments, central planning module 132, department-level view module 134, and apprentice-level view module 136 can be created as additional modules of HRMS 110 (similar to modules 112-120).

Further, it should be appreciated that the specific technologies used to implement the various entities/modules shown in system environment 100 may vary. For instance, in one embodiment, client-side UIs 138-142 generated by modules 132-136 of APMS 130 can be implemented as mobile applications designed to run on a smartphone or other mobile device (e.g., a tablet or smartwatch). Alternatively or in addition, client-side UIs 138-142 can be implemented as web-based interfaces that are designed to run within a conventional web browser. One of ordinary skill in the art will recognize many variations, modifications, and alternatives.

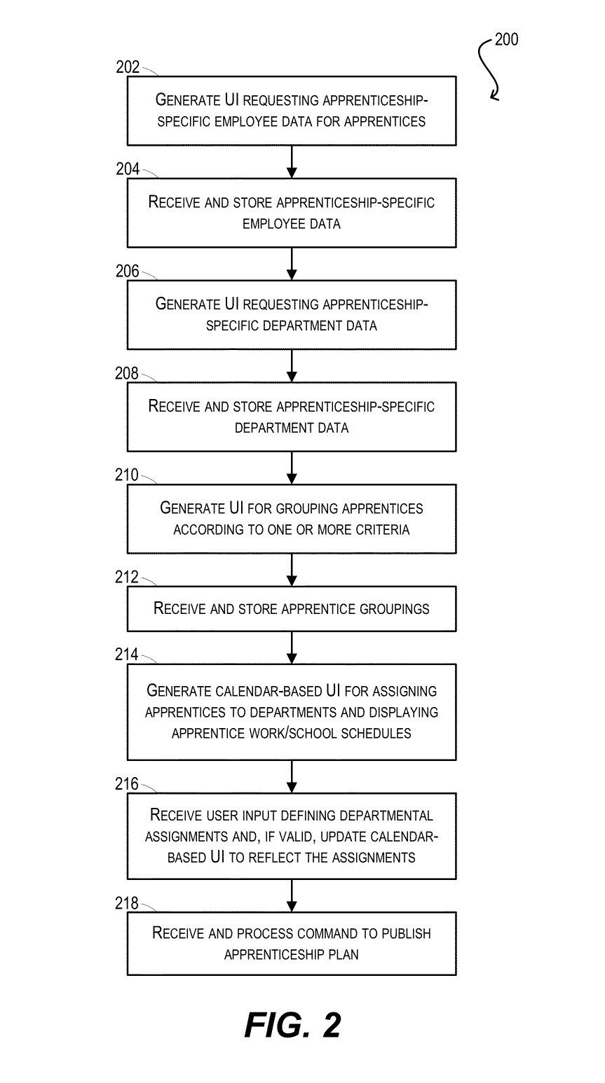

FIG. 2 depicts a flowchart 200 of a process that may be performed by central planning module 132 of APMS 130 for enabling a training supervisor of the company (operating, e.g., client device 108(1) shown in FIG. 1) to perform apprenticeship planning/administration functions according to an embodiment. Starting with block 202, central planning module 132 can generate a UI requesting apprenticeship-specific employee data for apprentices that have been hired by the company. This apprenticeship-specific employee data can include, e.g., apprenticeship year, trade/profession, class year, and school.

At block 204, central planning module 132 can receive the requested apprenticeship-specific employee data and can store the data in storage tier 106. In a particular embodiment, this data can be stored as part of one or more existing employee data objects/tables (i.e., 122) maintained by HRMS 110, thereby avoiding the need to create duplicate data records for each apprentice.

At block 206, central planning module 132 can generate a UI requesting apprenticeship-specific department data for each of the company departments participating in the apprenticeship program. This apprenticeship-specific department data can include, e.g., contact information for the apprentices of the department, off-periods for the department, preferences, and maximum capacity (i.e., the maximum number of apprentices the department can train).

At block 208, central planning module 132 can receive the requested apprenticeship-specific department data and can store the data in storage tier 106 Like the apprenticeship-specific employee data, the apprenticeship-specific department data can be stored as part of one or more existing department data objects/tables (i.e., 124) maintained by HRMS 110, thereby avoiding the need to create duplicate data records for each department.

At block 210, central planning module 132 can generate a UI for grouping the apprentices according to one or more criteria. For example, the apprentices can be grouped by trade/profession, apprenticeship year, class year, location, school, etc. At block 212, central planning module 132 can receive the groupings defined by the training supervisor and store the groupings in storage tier 106.

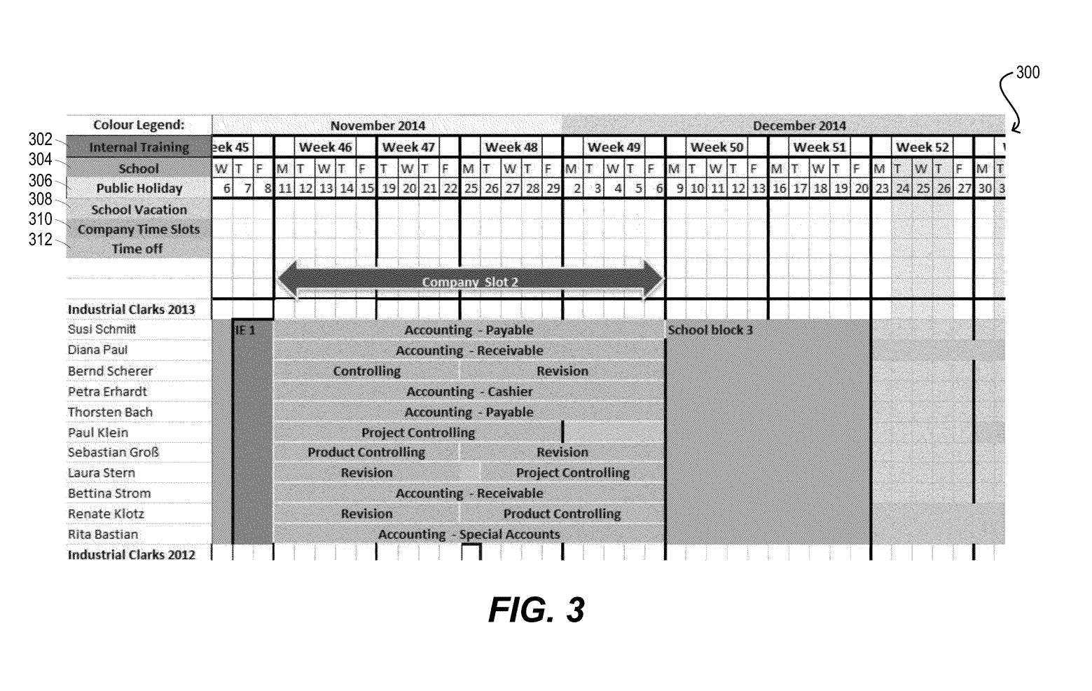

Then, at block 214, central planning module 132 can generate a calendar-based UI for assigning apprentices to departments (either on a per-apprentice or per-group basis) and viewing the schedules for each apprentice according to their departmental assignments. For instance, FIG. 3 depicts an example of such a calendar-based UI 300 according to an embodiment. As shown in FIG. 3, UI 300 depicts apprentices (grouped according to the groupings defined at block 212) along the Y-axis, a calendar timeline (e.g., days/weeks/months) along the X-axis, and calendar events for the apprentices within the intersecting cells. The training supervisor can assign apprentices to specific departments or sub-departments in UI 300 by, e.g., dragging-and-dropping department/sub-department indicators into cells corresponding to the apprentices for desired periods of time. Central planning module 132 can receive these user inputs and, if the assignments are valid, can update UI 300 to include new calendar events (specifically, departmental work periods) that reflect the newly-defined assignments (block 216). For example, in FIG. 3, apprentice “Susie Schmitt” is shown as being assigned to the “Accounting-Payable” department for the work period spanning weeks 46-49.

As part of generating calendar-based UI 300 at block 214, central planning module 132 can automatically populate the UI with events that are relevant to the apprentices. The events can include, e.g., internal training, school periods, holidays, school vacation, company work slots, and time-off (shown via legend elements 302, 304, 306, 308, 310, and 312 in FIG. 3).

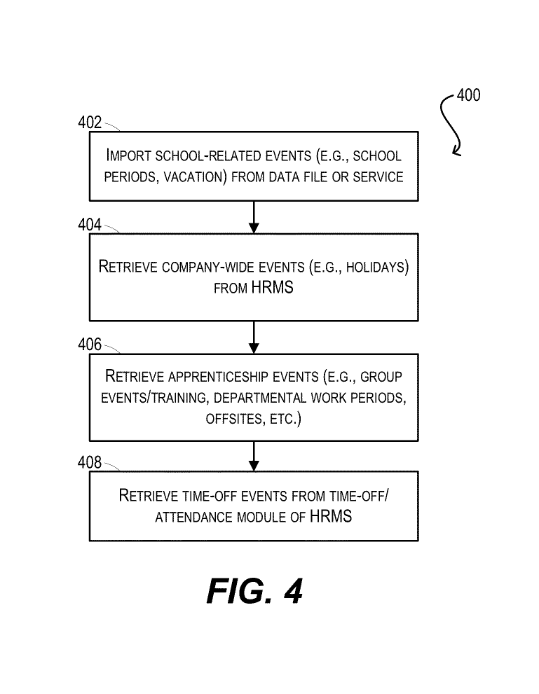

FIG. 4 depicts a flowchart 400 for performing this processing according to an embodiment. At block 402, central planning module 132 can import school-related events for each apprentice or apprentice group, such as school periods and vacation, from a data file or service made available by the apprentices' schools. At block 404, central planning module 132 can retrieve company-wide events (e.g., holidays) from HRMS 110. At block 406, central planning module 132 can retrieve apprenticeship-specific events (e.g., group events, internal (departmental or learning) training, departmental work periods, offsites, etc.) from one or more modules of HRMS 110 and/or learning/training management system 118. And at block 408, central planning module 132 can retrieve time-off events from data objects/tables 126 associated with time-off/attendance module 116, thereby capturing the time-off days requested by the apprentices via module 126. In a particular embodiment, the time-off events shown in UI 300 can indicate the current status of each request (e.g., requested or approved).

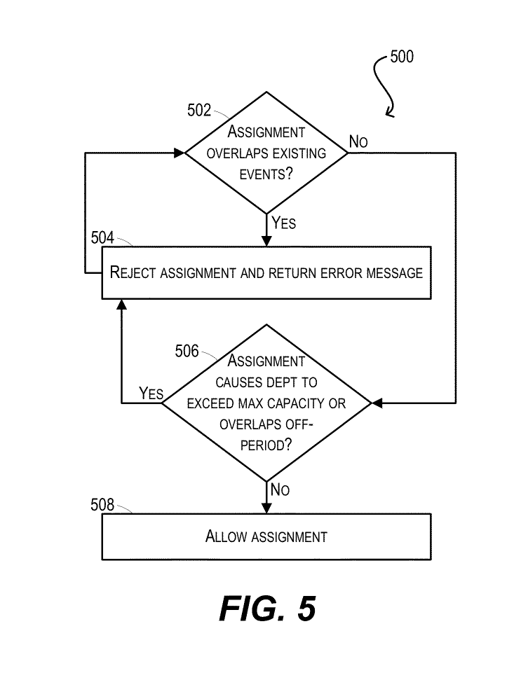

Further, as part of updating calendar-based UI 300 at block 216 of FIG. 2, central planning module 132 can validate whether the departmental assignments entered by the training supervisor are allowed. FIG. 5 depicts a flowchart 500 for performing this validation according to an embodiment. At block 502, central planning module 132 can check whether a departmental assignment for a given apprentice overlaps one or more other existing events for the apprentice shown in the calendar. If so, central planning module 132 can reject the assignment and return an appropriate error message to the training supervisor (block 504). The training supervisor can then attempt to revise the assignment and flowchart 500 can loop back to block 502.

If the departmental assignment does not overlap any existing events, central planning module 132 can check whether the assignment causes the department to exceed its maximum capacity or overlaps a department off-period (as defined by the training supervisor at block 206 of FIG. 2) (block 506). If so, central planning module 132 can reject the assignment and return an appropriate error message to the training supervisor as above (block 504).

Otherwise, central planning module 132 can allow the assignment (block 508) and flowchart 500 can end.

Returning to FIG. 2, once the training supervisor has completed assigning apprentices to departments via block 216, the training supervisor can optionally reconfigure the UI according to different views (e.g., per apprentice, per department, per apprentice group, etc.) in order to gain a better understanding of the apprentices' schedules (not shown). Finally, at block 218 of FIG. 2, central planning module 132 can receive and process a command from the training supervisor for publishing the assignments (collectively referred to as an “apprenticeship plan”). In this manner, the assignments and associated schedules can be made viewable by the other stakeholders/participants in the program (e.g., department administrators and apprentices).

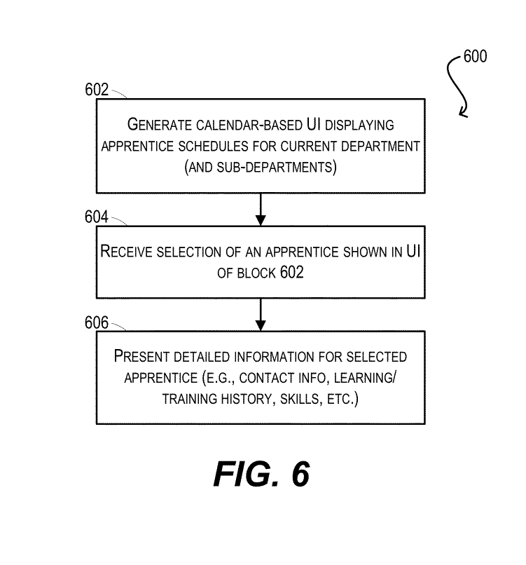

FIG. 6 depicts a flowchart 600 of a process that may be performed by department-level view module 134 of APMS 130 for enabling a department administrator (operating, e.g., client device 108(2) shown in FIG. 1) to view information regarding the apprentices assigned to his/her department according to an embodiment. Flowchart 600 assumes that the training supervisor has published an apprenticeship plan for the company per block 218 of FIG. 2.

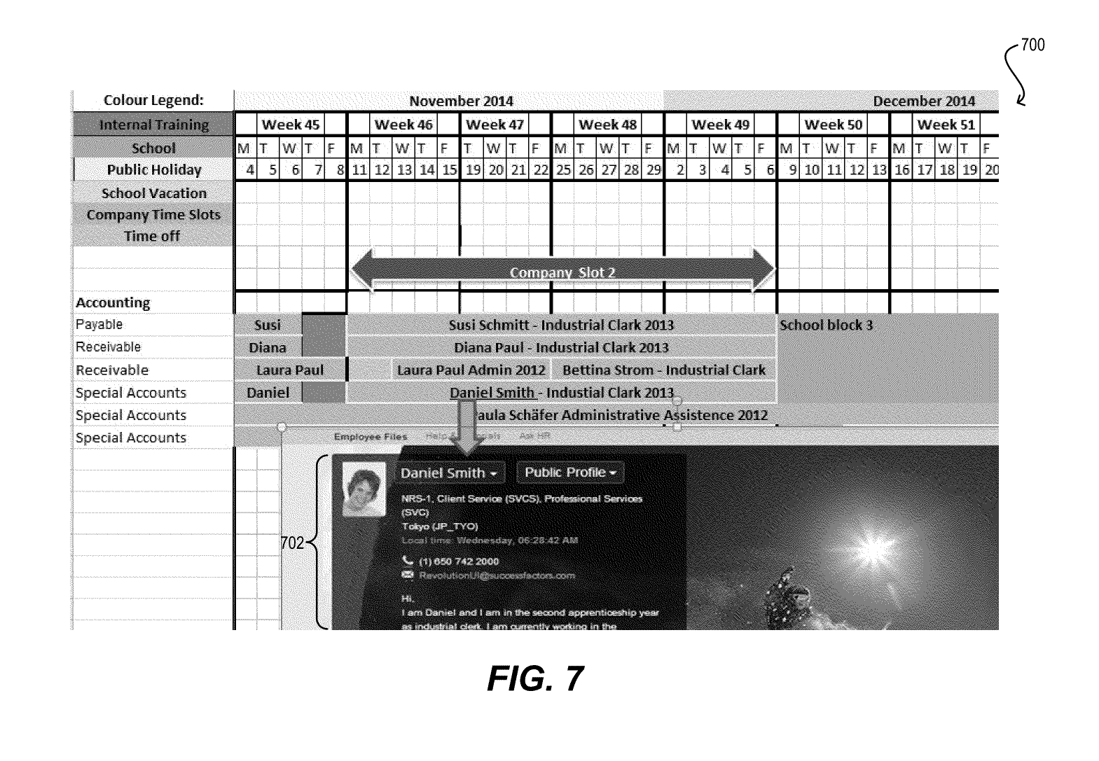

Starting with block 602, department-level view module 134 can generate a calendar-based UI displaying the schedules for the apprentices assigned to the administrator's department. FIG. 7 depicts an example of such a calendar-based UI 700 according to an embodiment. As can be seen, UI 700 is similar to UI 300 of FIG. 3, but depicts a particular department (and constituent sub-departments) along the Y-axis, and the apprentices assigned to the sub-departments in the intersecting cells. Thus, with UI 700, the department administrator can easily identify which apprentices will be working for which sub-departments, and for how long.

UI 700 also depicts the various school and work-related events for the apprentices shown in UI 300, such as school periods, school vacation, holidays, internal training, work periods, and requested time-off. Department-level view module 134 can automatically pull information for these events from the same sources as central planning module 132.

In certain embodiments, department-level view module 134 can receive a selection of a particular apprentice in UI 700 from the department administrator (block 604). For instance, the department administrator can hover (using, e.g., a mouse) over the apprentice's name, or click on the apprentice name. In response, department-level view module 134 can present detailed information regarding the selected apprentice, such as his/her contact information, learning/training history, skills, and apprenticeship-specific information entered by the training administrator via the central planning UIs (e.g., apprenticeship year, school, class year, etc.) (block 606). An example of this detailed information is shown in UI 700 via window 702. In this manner, the department administrator can get a better sense of the skills and knowledge of each incoming apprentice, and thereby plan the apprentice's training regime appropriately. In a particular embodiment, department-level view module 134 can import the apprentice detail information shown in window 702 from various existing data objects/tables maintained by HRMS 110, such as employee data objects/tables 122 and learning/training data objects/tables 128.

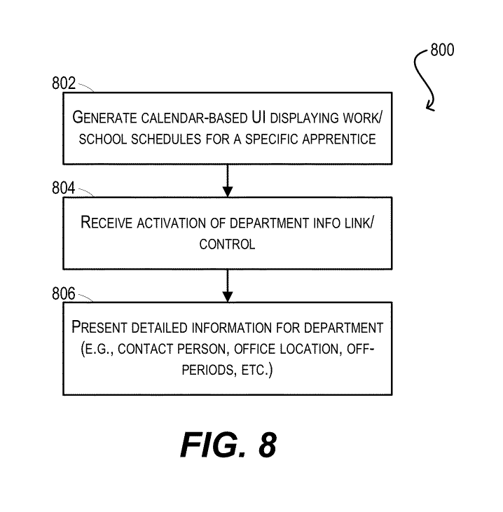

FIG. 8 depicts a flowchart 800 of a process that may be performed by apprentice-level view module 136 of APMS 130 for enabling an apprentice (operating, e.g., client device 108(3) shown in FIG. 1) to view information regarding his/her apprenticeship according to an embodiment Like flowchart 600, flowchart 800 assumes that the training supervisor has published an apprenticeship plan for the company per block 218 of FIG. 2.

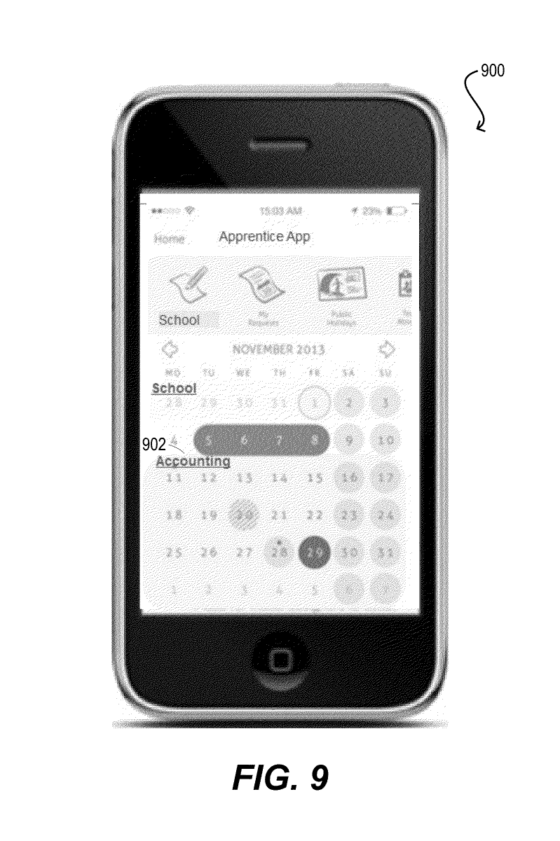

At block 802, apprentice-level view module 136 can generate a calendar-based UI that displays the apprentice's work and school schedule, as defined by the departmental assignment(s) made by the training supervisor via the central planning UIs. FIG. 9 depicts an example of such a calendar-based UI 900 according to an embodiment Like UIs 300 and 700, UI 900 shows various calendar events relevant to the apprentice, such as school periods, school vacation, work periods, internal training events, and requested time-off. Apprentice-level view module 136 can automatically pull information for these events from the same sources as central planning module 132 and department-level view module 134. However, unlike UIs 300 and 700, UI 900 is intended to provide a single apprentice with a personalized view of his/her appointments and commitments, rather than a company-wide or department-wide view. Thus, UI 900 does not display events that are specific to other apprentices in the same company or department.

In the particular example of FIG. 9, calendar-based UI 900 is shown as being implemented as a mobile application running on a smartphone. However, in alternative embodiments, calendar-based UI 900 can be implemented as, e.g., a web-based interface.

In some embodiments, the UI generated at block 802 of flowchart 800 can include a link or control that enables access to information regarding the department the apprentice has been assigned to work for. For instance, in FIG. 9, UI 900 includes an “Accounting” link 902. Upon receiving an activation of this link or control (block 804), apprentice-level view module 136 can present appropriate department information to the apprentice, such as the department contact person, office location, off-periods, and so on (block 806). In this way, the apprentice can easily figure out where he/she should be (and when), as well as who to contact if he/she has questions about the apprenticeship, via a single, unified UI.

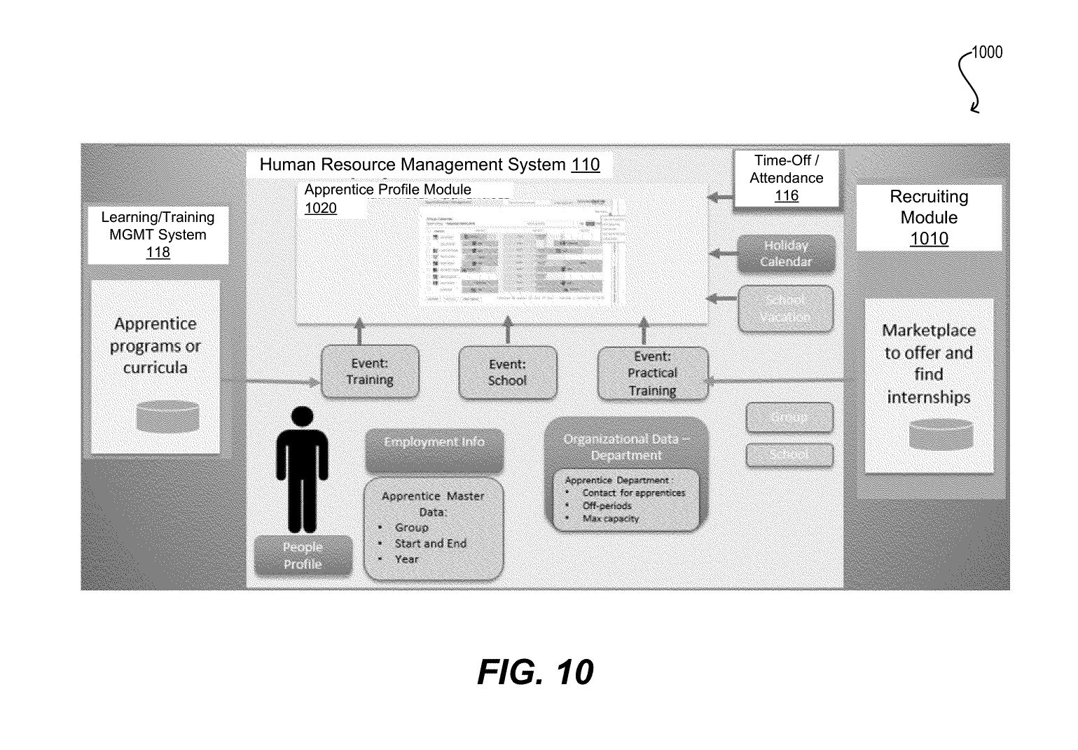

FIG. 10 depicts a system environment that includes a human resource management system according to an embodiment. As shown, system environment 1000 includes HRMS 110, learning/training management system 118, and recruiting module 1010. Recruiting module 1010 is configured to provide a marketplace that connects apprentices looking to find internships and departments looking to offer apprenticeships. HRMS 110 can communicate with learning/training management system 118 and recruiting module 1010 to assist in the scheduling events for an apprentice. Learning/training management system 118 can provide generic-apprenticeship events such as to online learning content or online training curricula while recruiting module 1010 can provide apprentice specific events such as on-the-job training. For example, trade work experience can include hands on experience in baking, tailoring, and carpentry.

HRMS 110 further includes multiple modules. Some of the modules are core modules that are part of HRMS 110 while others are add on modules which provide additional features for apprentice planning and management. Here, the add on modules can include apprentice profile module 1020, school vacation module, group module, school module, and apprentice master data module. Some core modules can be extended to store apprentice data. Here, organization data-department module has been extended to store data related to the apprentice department within the organization. The apprentice department data can include the on-site supervisor, off-periods in which no apprentice be assigned to the department, and maximum capacity of apprentices at a time. Apprentice profile module 1020 can be configured to generate an apprentice profile by using information within HRMS 110 and events received from learning/training management system 118 and recruiting module 1010.

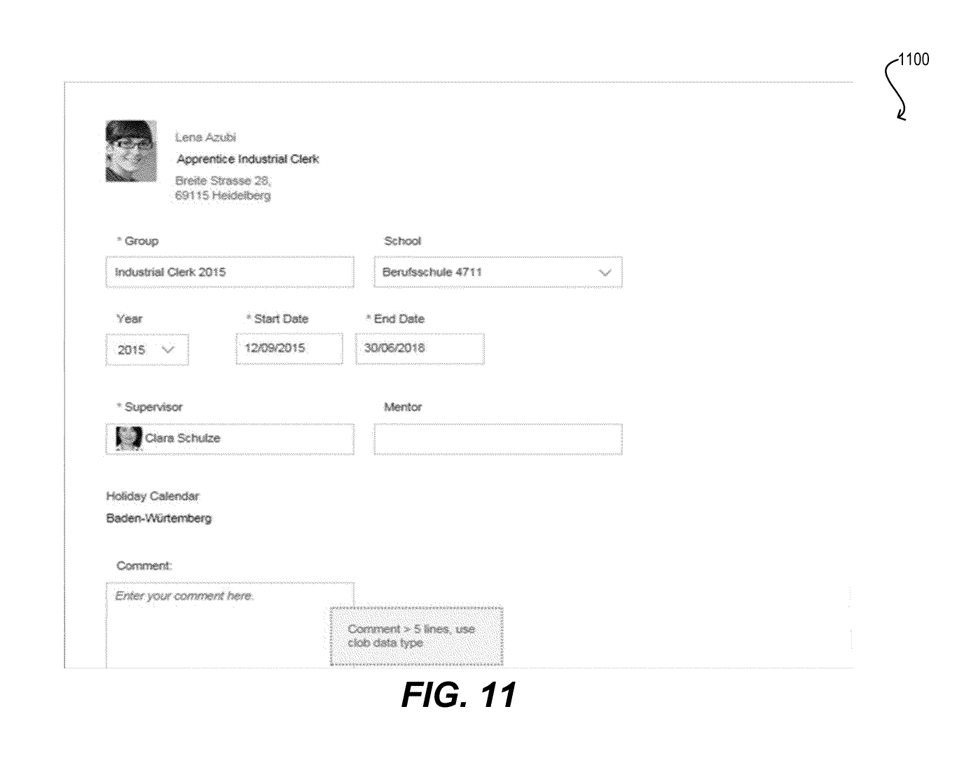

FIG. 11 depicts an apprentice master data according to an embodiment. Apprentice master data 1100 is an extension of employment information and can include data fields to store apprentice-specific employee data. Apprentice-specific employee data can include the group which the apprentice belongs to, the school the apprentice is attending, the start and stop date for the apprenticeship, the apprentice's supervisor, and the apprentice's mentor.

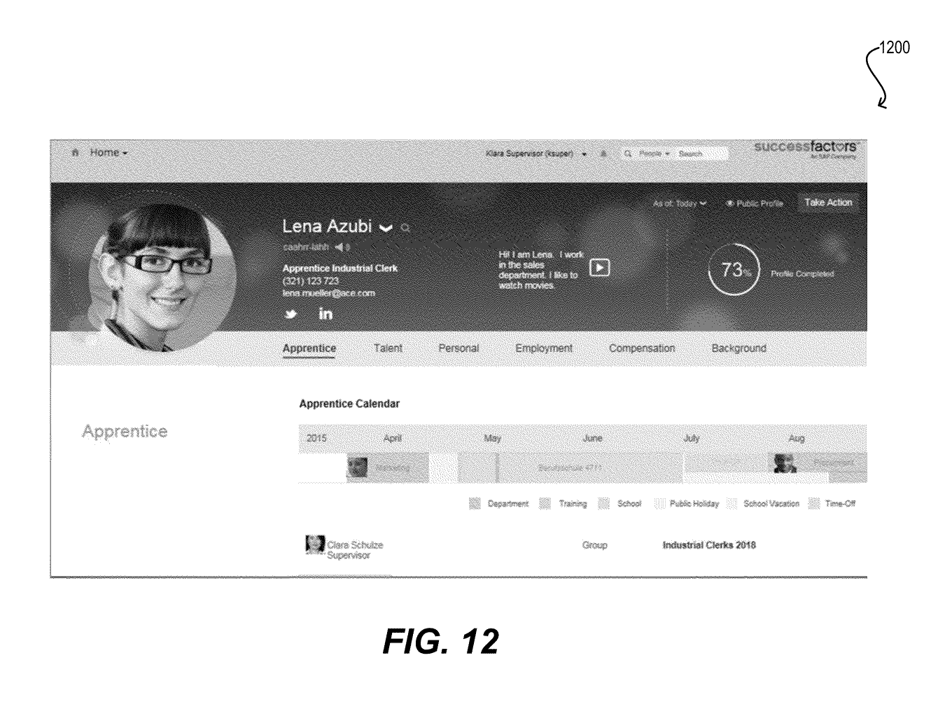

FIG. 12 depicts an apprentice profile according to an embodiment. Apprentice profile 1200 can be generated based on an employee request. The apprentice profile is generated by populating a presentation layout with information of the apprentice and the apprentice's schedule. Depending on the requesting employee's work relationship with the apprentice (e.g., manager-apprentice, supervisor-apprentice, or mentor-apprentice) or the requesting employee's role within the company and the therefore maintained permissions, an apprentice profile is generated. The profile 1200 is generated according to a presentation layout and permission proposal that is for employees within the company who do not have a work relationship with the apprentice. Since the requesting employee does not have an existing work relationship with the employee, the presentation layout can be one which provides a generic representation of the apprentice. As shown, apprentice profile 1200 includes a photo of the apprentice along with the apprentice's name, apprenticeship trade, phone number, and email address. The apprentice's supervisor and group is also included in the apprentice profile (as specified in the presentation layout).

Apprentice profile 1200 further includes an apprentice calendar illustrating scheduled events of the apprentice within a timeline. As shown, the apprentice calendar includes a calendar timeline along the x-axis and scheduled events that are represented as blocks along the calendar timeline. A visual indicator such as highlighting can be applied to each block to signify the type of event that has been scheduled. For example, departmental events can be highlighted blue while school events are highlighted pink. Text can also be presented within the block to provide a short description for the scheduled event.

In some embodiments, a photo can also be accompanied within the block to indicate the contact person for the scheduled activity. For example, the block representing the marketing event scheduled in April includes a photo of the on-site supervisor for the marketing department. This allows the apprentice (or other employee within the company) to quickly identify the person whom the apprentice will be reporting to during the scheduled activity.

In some embodiments, two scheduled events overlap. In these instances of overlapping events, blocks are generated which are stacked on top of one another in the calendar timeline. This allows both overlapping events to be presented simultaneously within the calendar timeline. In one example, the blocks which are associated with the overlapping events can be divided in half so that the overlapping blocks can occupy the same amount of space within the calendar timeline. For example, a first block representing a school vacation is presented within the calendar timeline as starting at the beginning of July and ended in the middle of August. If the apprentice plans to go on leave within this period, a time-off event overlaps the school vacation, a dimension of the block representing the school vacation is reduced so that the block representing the time-off event and the block representing the school vacation event can be simultaneously presented along the calendar timeline. As shown here, the block representing the time-off event is stacked on top of the block representing the school vacation. The block representing the school vacation event can be presented slightly narrower than the block representing the time-off event to ensure that there is enough height to present an image along with the block representing the procurement event (practical training). The calendar UI can take into consideration the height requirements of neighboring blocks when adjusting the height for a given block. The features of adding in a photo to a block and overlapping of the blocks can also be applied to the department-level view when viewing the schedules of all apprentices that have been assigned to that department.

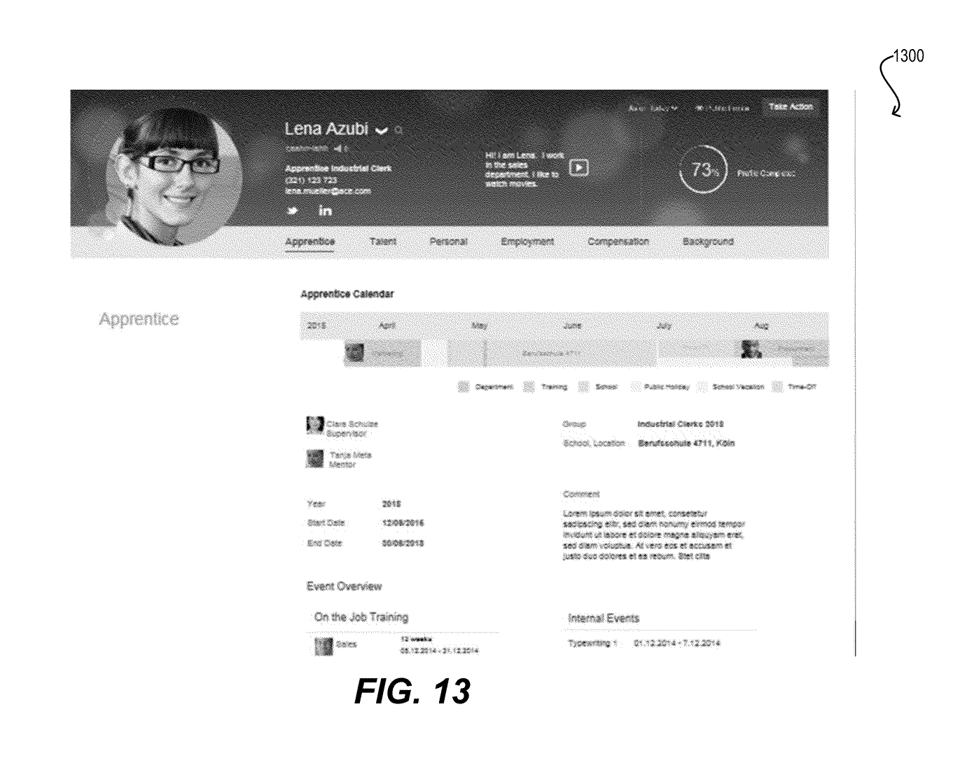

FIG. 13 depicts another apprentice profile according to another embodiment. Here, the presentation layout is configured to provide a detailed representation of the apprentice. Apprentice profile 1300 is generated by populating a detailed presentation layout that includes all the fields within the generic presentation layout used in generating apprentice profile 1300. The detailed presentation layout includes additional fields such as the apprentice's mentor, apprentice's start/end date, apprentice's school, comments on the apprentice, and an event overview containing upcoming job training events that have been assigned to the apprentice.

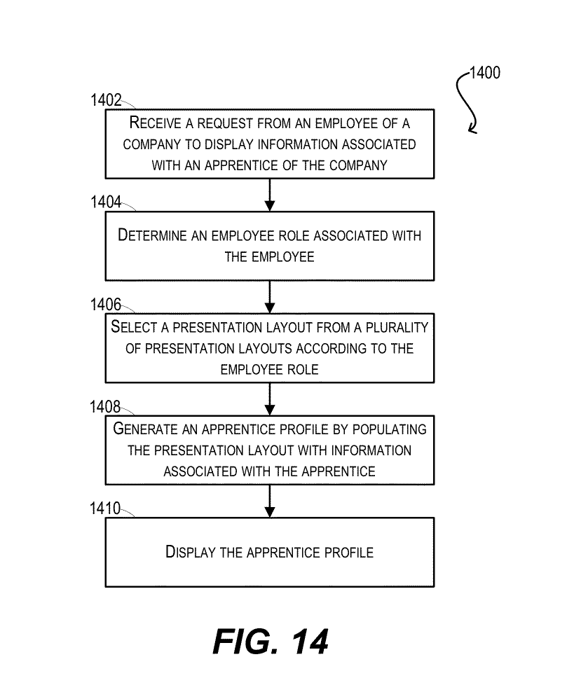

FIG. 14 depicts a flowchart for generating the apprentice profile of FIG. 12 according to an embodiment. Starting with block 1402, the apprentice profile module can receive a request from an employee of a company to display information associated with an apprentice of the company. The information can include apprenticeship-specific employee data and also non-apprenticeship specific employee data.

At block 204, the apprentice profile module can determine an employee role associated with the employee. In a particular embodiment, the employee role can be with respect to the company. For example, the employee role can be supervisor. In another embodiment, the employee role can be the working relationship between the employee and the apprentice. For example, the employee role can be mentor-apprentice or on-site supervisor.

At block 206 the apprentice profile module can select a presentation layout from a plurality of presentation layouts according to the employee role and permission settings. Many presentation layouts can be made available to the apprentice profile module. The apprentice profile module can select one of the presentation layouts by matching the employee role to a particular presentation layout.

At block 208 the apprentice profile module can generate an apprentice profile by populating the presentation layout with the information associated with the apprentice. The apprentice profile module can populate the presentation layout with detailed information on the apprentice such as the apprentice's contact information, learning/training history, skills, scheduled events, etc. At block 210, the apprentice profile module can display the generated apprentice profile.

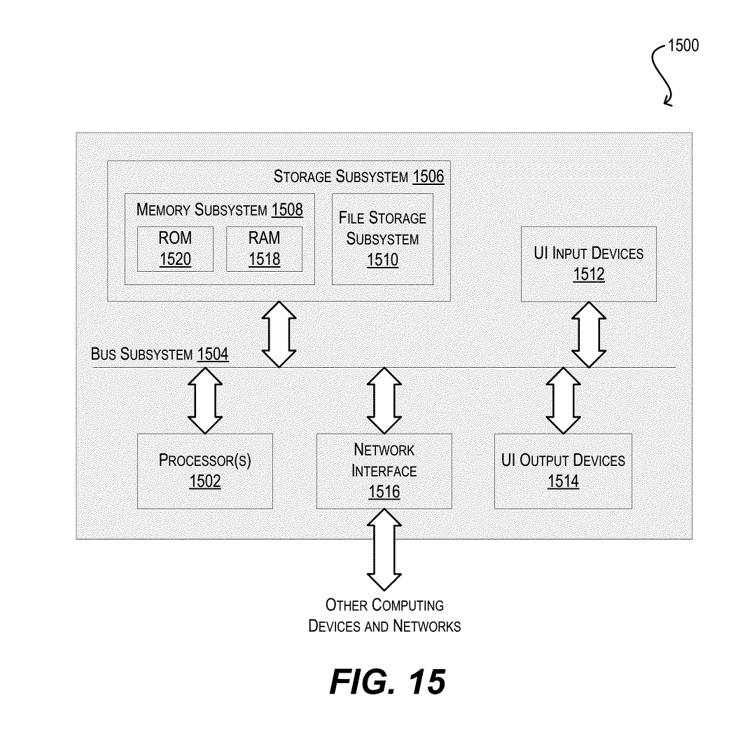

FIG. 15 depicts an exemplary computer system 1500 according to an embodiment. Computer system 1500 can be used to implement the various devices/systems described in the foregoing disclosure, such as the servers of server tier 104 and/or client devices 108(1)-108(N) of FIG. 1. As shown, computer system 1500 includes one or more processors 1502 that communicate with a number of peripheral devices via a bus subsystem 1504. These peripheral devices include a storage subsystem 1506 (comprising a memory subsystem 1508 and a file storage subsystem 1510), user interface input devices 1512, user interface output devices 1514, and a network interface subsystem 1516.

Bus subsystem 1504 can provide a mechanism for letting the various components and subsystems of computer system 1500 communicate with each other as intended. Although bus subsystem 1504 is shown schematically as a single bus, alternative embodiments of the bus subsystem can utilize multiple buses.

Network interface subsystem 1516 can serve as an interface for communicating data between computer system 1500 and other computing devices or networks. Embodiments of network interface subsystem 1516 can include wired (e.g., coaxial, twisted pair, or fiber optic Ethernet) and/or wireless (e.g., Wi-Fi, cellular, Bluetooth, etc.) interfaces.

User interface input devices 1512 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 1500.

User interface output devices 1514 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 1500.

Storage subsystem 1506 includes a memory subsystem 1508 and a file/disk storage subsystem 1510. Subsystems 1508 and 1510 represent non-transitory computer-readable storage media that can store program code and/or data that provide the functionality of various embodiments described herein.

Memory subsystem 1508 can include a number of memories including a main random access memory (RAM) 1518 for storage of instructions and data during program execution and a read-only memory (ROM) 1520 in which fixed instructions are stored. File storage subsystem 1510 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1500 is illustrative and not intended to limit embodiments of the present invention. Many other configurations having more or fewer components than computer system 1500 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A computer implemented system, comprising:
one or more computer processors; and
a non-transitory computer-readable storage medium comprising instructions, that when executed, control the one or more computer processors to be configured for:
receiving a request from an employee of a company to display information associated with an apprentice of the company;
determining an employee role associated with the employee; and
selecting a presentation layout from a plurality of presentation layouts according to the employee role, wherein each of the plurality of presentation layouts are configured to display a subset of the information in a particular arrangement;
generating an apprentice profile by populating the presentation layout with the information associated with the apprentice; and
displaying the apprentice profile.

2. The computer implemented system of claim 1, wherein the presentation layout includes a calendar-based user interface configured to display calendar events relevant to the apprentice.

3. The computer implemented system of claim 2, wherein each of the calendar events are displayed along a calendar timeline of the calendar-based user interface.

4. The computer implemented system of claim 3, wherein the calendar events include school events, school vacation events, public holiday events, training events, time-off events, and department events.

5. The computer implemented system of claim 4, wherein a department event is presented with a department name and an image associated with a manager of the department.

6. The computer implemented system of claim 4, wherein a first portion of a first calendar event is displayed on top of a second portion of a second calendar event when the first calendar event and the second calendar event occur at the same time.

7. A method comprising:
receiving, by a computer system, a request from an employee of a company to display information associated with an apprentice of the company;
determining, by the computer system, an employee role associated with the employee; and
selecting, by the computer system, a presentation layout from a plurality of presentation layouts according to the employee role, wherein each of the plurality of presentation layouts are configured to display a subset of the information in a particular arrangement;
generating, by the computer system, an apprentice profile by populating the presentation layout with the information associated with the apprentice; and
displaying, by the computer system, the apprentice profile.

8. The method of claim 7, wherein the presentation layout includes a calendar-based user interface configured to display calendar events relevant to the apprentice.

9. The method of claim 8, wherein each of the calendar events are displayed along a calendar timeline of the calendar-based user interface.

10. The method of claim 9, wherein the calendar events include school events, school vacation events, public holiday events, training events, time-off events, and department events.

11. The method of claim 10, wherein a department event is presented with a department name and an image associated with a manager of the department.

12. The method of claim 10, wherein a first portion of a first calendar event is displayed on top of a second portion of a second calendar event when the first calendar event and the second calendar event occur at the same time.

13. The method of claim 7, wherein a first presentation layout associated with a supervisor of the apprentice is configured to display more information than a second presentation layout associated with a non-supervisor of the apprentice.

14. A non-transitory computer readable storage medium storing one or more programs, the one or more programs comprising instructions, which when executed by a processor, cause the processor to execute a method of:
receiving a request from an employee of a company to display information associated with an apprentice of the company;
determining an employee role associated with the employee; and
selecting a presentation layout from a plurality of presentation layouts according to the employee role, wherein each of the plurality of presentation layouts are configured to display a subset of the information in a particular arrangement;
generating an apprentice profile by populating the presentation layout with the information associated with the apprentice; and
displaying the apprentice profile.

15. The non-transitory computer readable storage medium of claim 14, wherein the presentation layout includes a calendar-based user interface configured to display calendar events relevant to the apprentice.

16. The non-transitory computer readable storage medium of claim 15, wherein each of the calendar events are displayed along a calendar timeline of the calendar-based user interface.

17. The non-transitory computer readable storage medium of claim 16, wherein the calendar events include school events, school vacation events, public holiday events, training events, time-off events, and department events.

18. The non-transitory computer readable storage medium of claim 17, wherein a department event is presented with a department name and an image associated with a manager of the department.

19. The non-transitory computer readable storage medium of claim 17, wherein a first portion of a first calendar event is displayed on top of a second portion of a second calendar event when the first calendar event and the second calendar event occur at the same time.

20. The non-transitory computer readable storage medium of claim 14, wherein a first presentation layout associated with a supervisor of the apprentice is configured to display more information than a second presentation layout associated with a non-supervisor of the apprentice.
